(19) United States
(12) Patent Application Publication
(10) Pub. No.: US 2004/0135716 A1
(43) Pub. Date: Jul. 15, 2004

(54) Laser rangefinder decoy systems and methods

(76) Inventor: John R. Wootton, St. Louis, MO (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 10/315,760

(22) Filed: Dec. 10, 2002

(51) Int. Cl. H04K 3/00

(52) U.S. Cl. 342/13

(57) ABSTRACT

Described herein, amongst other things, are laser rangefinder decoy systems, devices, and methods which decoy a laser rangefinder from giving the correct range to a target. Embodiments of the systems may provide “ghost” signals which are perceived to be the target; may provide for inaccurate indications of motion of the target and/or ghost; and/or may hide a targets true signature in a modified signal.

### BACKGROUND OF THE INVENTION

1. Field of the Invention

This disclosure relates to the field of laser decoy systems and methods. In particular, to systems and methods for use on combat vehicles to provide inaccurate signal returns to laser rangefinders.

2. Description of the Related Art

Almost since their discovery, lasers have been used by the military for the targeting of enemy units for ordnance delivery against that target. Lasers are used in many forms for their task at ordnance delivery, including rangefinders, target designators, and in other applications where a laser beam can be bounced off an enemy target to produce useful information. In use, some lasers are steady, while others are pulsed. Further, lasers can be used by all types of military resources from individual infantrymen, specialized targeting vehicles (such as those for forward observation), armored fighting vehicles (such as tanks), and even by watercraft or aircraft.

One common utilization of the laser is to act as a rangefinder. This type of arrangement is particularly common in conjunction with armored fighting vehicles such as tanks or for forward observation vehicles. When used on tanks, targeting generally occurs as follows: a vehicle crewman will identify a potential target, the tank gunner will then locate the identified target (such as an enemy tank) in their eyepiece and place a reticle on the target. They will then track the target with the reticle while they trigger the rangefinder. The target is then illuminated by a laser beam emitted by the rangefinder. The time it takes for the laser beam to project from the rangefinder and return to the rangefinder (having reflected off the target) is then determined. This time can then be used to mathematically compute the distance the laser traveled and the range to the target.

In order to locate the target's reflection, a processor or computer is used to analyze all the light that is impinging on the targeting system using various processes to segregate the laser light reflection from the target from light noise (such as reflections from other objects or ambient light). Once the laser light from the target is segregated, the processor computes the distance to it based on the known position and movement of the rangefinder. The rangefinder can then be tied into the particular weapons system. In the case of a tank, the information is used to aim the main gun in a manner predicted to hit the target. Such a calculation can include assimilation of information from other on-board systems such as gyroscopes and wind gauges to accurately compute the predicted flight path of the desired ordnance. When this process is completed, the gunner may then be provided with an indication that the weapon systems is ready, and the gunner may fire on the target. The single, most important parameter in effectively delivering ordnance onto a target is the accurate measurement of range.

Other embodiments of rangefinders are even more sophisticated. Many rangefinders utilize pulsed or other time sensitive laser sources to rapidly calculate the speed and direction that a target is moving relative to the rangefinder based on changes during the range finding activity. This allows for the weapon fired to compensate for that movement and hit the target. This activity is generally performed by having each “pulse” of the laser occur at known time intervals with multiple pulses being directed at the same target during a single range-finding activity. The processor receives the reflection of the pulsed laser beam and the return signals from the target are separated from noise as above. The processor then combines the calculated distance of the target at each pulse with the time between the pulses to determine the speed of the vehicle's movement toward or away from the rangefinder. This information can then be combined with any other information such as the gunner's adjustment to keep the target in the reticle (which provides movement side-to-side relative to the rangefinder) to compute the motion (both speed and direction) of the target relative to the rangefinder, and to target the weapon system to anticipate the target's expected position at the time the ordnance is delivered based on this motion.

Laser rangefinders generally segregate the reflected signal representing the target from the light noise present by using various systems to pull the target signal out of the noise. In particular, a processor associated with the rangefinder will monitor the light detected at the rangefinder for indications that a portion of this light is that which was generated by the rangefinder and has reflected off the target. General light noise (e.g. from another rangefinder, from sunlight, or from other sources not part of the rangefinder system) can be edited out by filters which filter the light received at the rangefinder so that only light around the specific frequency used by the rangefinder is received. In more sophisticated systems, frequency encoding or similar techniques which make the laser's light even more unique and identifiable by encoding the laser's light with information specific to the rangefinder can also or alternatively be used.

Even with light filtering systems, noise will still be received by the rangefinder as the laser will reflect off of more than just the target as the beam dissipates over the course of its projection. In particular, it will reflect off the ground, nearby vegetation and any other objects which may be nearby the target. The processor generally separates out this noise (which is the same light as that reflected from the target and so cannot be filtered) by looking for a particularly large spike of reflection using a threshold detector. The large spike occurs because the target is generally the largest, most reflective object in the view of the rangefinder when the gunner triggers the rangefinder. Therefore, when the rangefinder is triggered (when the laser light is projected), the computer generally searches through a small window of data for the largest reflection in time, which is generally in the form of a spike within a particular distance window, i.e. time period, presuming that the spike represents the target, and then uses this information to position the main gun to hit the object at the distance represented by that spike.

Laser rangefinders have proven very effective at targeting and are in use by many major militaries. Once the target has been illuminated with the laser rangefinder, the danger to them is clear. Being illuminated by a laser rangefinder, generally implies that a weapon is being directed at their position, and often the time from laser illumination to the time of ordnance impact is relatively short.

To try and combat the threat presented by laser rangefinders, systems have been created which can be attached to a vehicle to warn its crew that they have been illuminated and need to respond to an imminent threat. The warning systems traditionally have operated as threshold detectors similar to those used by the rangefinder. In particular, the detectors are always sampling the light illuminating the vehicle (generally filtering to particular spectrums where laser targeters are used) and when they receive a spike of intensity (a likely indication that a laser system has illuminated the target), they provide a warning to the crew that they have probably been targeted by a laser targeter.

While these devices have been fairly good at detecting the presence of a laser, the limitation on these devices is that they can only provide warning of the presence of a laser beam. They do nothing to prevent the ordnance from still reaching the target. To put it more simply, these systems warn of a danger, while not necessarily preventing the ordnance from achieving its goal of hitting the target. Instead, the target is responsible for taking evasive maneuvers to attempt to change their motion significantly enough to defeat the position calculations made by the processor of the firer before the shell impacts. This is generally ineffective because of the short available time. Knowledge of the imminent danger is often not enough to spare the target as there realistically is simply insufficient time to carry out evasive actions before impact. In some situations, effective retaliation is improbable as the target may be doomed as soon as the laser beam illumination is detected. The loss of tanks or other assets with a low probability of retaliation is clearly undesirable from a strategic point of view. It would be highly desirable for a potential target to be able to “spoof” a laser rangefinder so that the targeting enemy misses and allows the target to respond and hopefully neutralize the original firer. In the case of tank engagements, it also would be desirable because a firing tank gives away its own position by its muzzle flash, the location of which can then be easily targeted by the intended target of that tank. Under the current system, however, an enemy utilizing a laser rangefinder or other laser targeter, is relatively safe from retaliation as it will generally destroy its target with its first engagement, and the direction of the laser then is relatively difficult to ascertain.

### SUMMARY

Because of these and other problems known to those familiar in the art, it is therefore desirable to have a laser rangefinder decoy system which will decoy a laser rangefinder from giving the correct range to a target. In particular, the system preferably provides a mechanism for causing an inaccurate range to the target by generating a reflected laser spike having identical characteristics as the transmitted signal and the specularly reflected target signal, but is of a higher amplitude than the specularly reflected signal, and generates an indication of longer range than the proper signal. Alternatively, the system “walks” the range gate off the target by providing indications of movement of the target which are not actually occurring. The system is preferably designed to be functional under combat or other battlefield conditions and relatively simple and inexpensive to manufacture.

In an embodiment there is herein described a laser decoy system comprising: a reflector; a walk coil having first and second ends; the first end operatively attached to the reflector such that light incident on the reflector is directed into the coil; and a mirror operatively connected to the coil such that light traveling from the first end of the coil toward the second end of the coil is deflected by the mirror to travel from the second end of the coil toward the first end of the coil; wherein light waves incident on the reflector from a first angle are directed into the coil, reflected from said mirror, returned to the reflector and are reflected back at a second angle generally being the opposite of the first angle.

In an embodiment, the reflector may have total internal reflectance and/or the walk coil may comprise a strand of fiber optic cable which may or may not be coiled.

In an embodiment, the mirror is located within the walk coil and/or at second end of the walk coil and may be able to move relative to the second end.

In another embodiment the walk coil may include a plurality of mirrors and/or at least one beam splitter.

### BRIEF DESCRIPTION OF THE FIGURES

FIG. 1 provides a depiction of an embodiment of a laser range finder decoy system as viewed from the front.

FIG. 2 provides a depiction of an embodiment of a laser decoy system as viewed from the top to show the light path.

FIG. 3 provides a depiction of a hypothetical return signal that could be received by the laser rangefinder showing how it is deceived.

FIG. 4 provides a depiction of how a motion generating decoy can hide the true target signal, 4A shows the target signal only, 4B shows the decoy signal only and 4C shows the composite of the two as received by the rangefinder showing how the actual target signal cannot be segregated from the decoy.

### DETAILED DESCRIPTION OF PREFERRED EMBODIMENT(S)

Although the laser rangefinder decoy systems and related methods described below are discussed primarily in terms of their use for decoying a laser rangefinder being used to illuminate one military vehicle by another military vehicle in a combat situation, it would be recognized by one of ordinary skill in the art that the systems and methods herein disclosed could be used for decoying any type of laser or other light or electromagnetic radiation producing system into an inaccurate measurement or calculation for any reason.

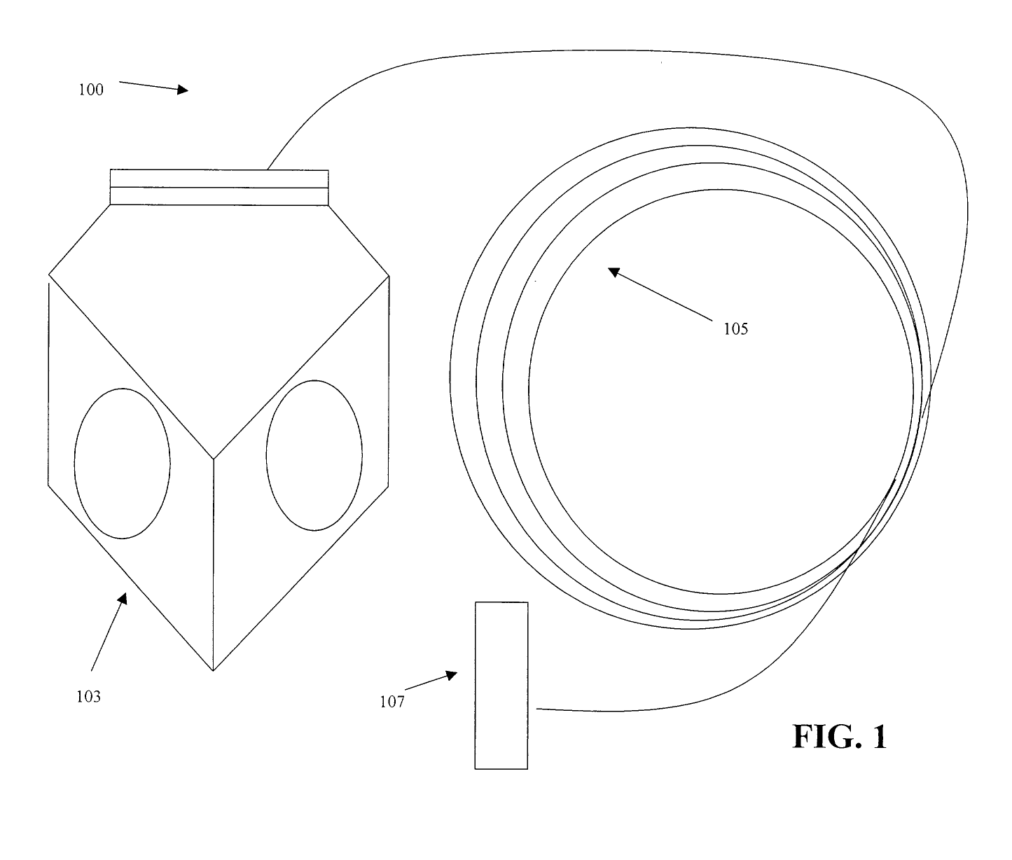

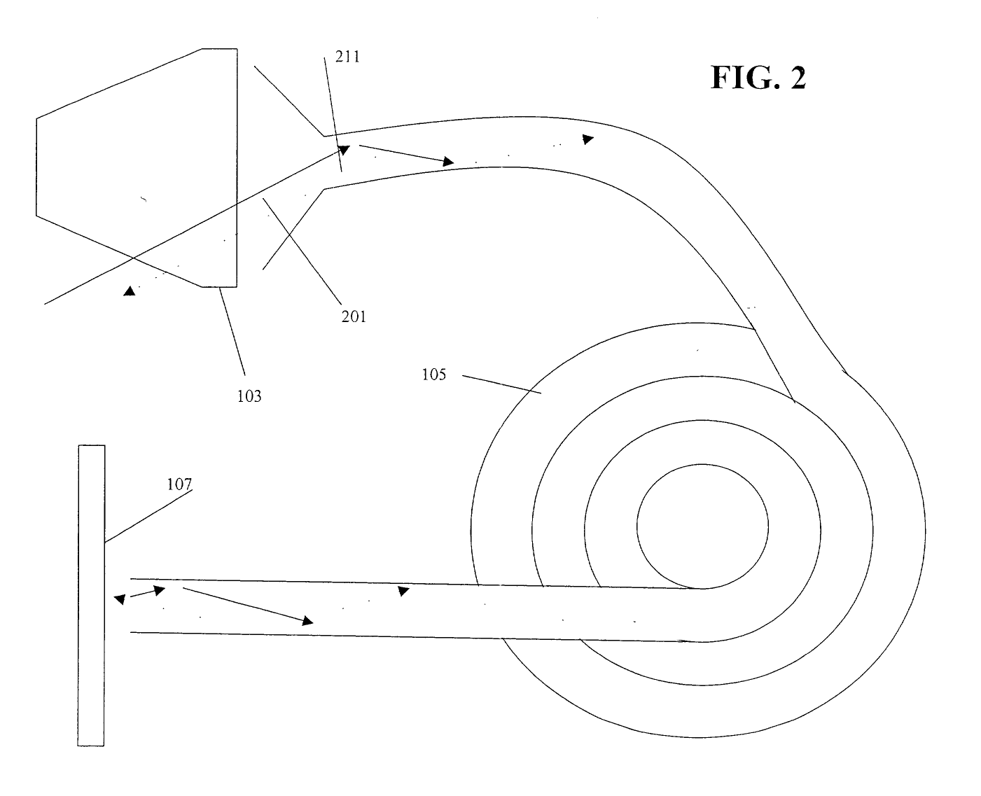

FIGS. 1 and 2 provide for a depiction of an embodiment of a laser decoy (100). Laser decoy (100) includes three primary components, a reflector (103), a walk coil (105) and a mirror (107). Laser rangefinders often use sophisticated encoding devices so that the rangefinder can verify that the laser beam it produced is the same beam that it is now seeing reflected back to it. This generally prevents spoofing by sending back alternatively generated laser beams. These encoding devices generally function by placing a particular pattern, waveform, or other information within the laser beam itself so that the rangefinder can review the received illumination and pick out the laser beam from any other laser beams or any light noise present. Because these encoding schemes can become quite complex, it is generally difficult for a target illuminated by a laser to accurately generate a false return signal from a new laser source which would be thought by the rangefinder to be a reflection of its original signal.

Therefore in the embodiment of FIGS. 1 and 2 the decoy (100) returns the actual laser beam illuminating the target, but provides the laser beam with a signal to falsely represent the target. In this way the beam that is returned will have identical frequency, phase, and/or pulse shape, as the reflection from the vehicle while carrying the false information provided by the decoy (100).

There are two primary ways to defeat a laser rangefinder system. In the depicted embodiment, the laser is supplied with false information that is interpreted by the rangefinder as the correct information. In an alternative embodiment, the system can simply create so much noise and/or so many false signals that the rangefinder cannot determine which signal is accurate, and the system will be forced to guess at which represents the correct information from the target. Such an embodiment can be constructed using a similar system to that depicted without undue experimentation.

In order to return the laser beam back to its source, decoy (100) utilizes reflector (103) for this purpose. Reflector (103) is preferably a “retro-reflector,” a corner reflector, a corner cube reflector or another similar design as otherwise known to one of ordinary skill in the art. One such reflector (103) is discussed in U.S. Pat. No. 5,459,470 the entire disclosure of which is herein incorporated by reference. The reflector (103) preferably has total internal reflectance. In FIGS. 1 and 2 only a single 45° reflector (103) is shown. One of ordinary skill in the art would understand that to cover a full 360° around the target, eight sections may be arranged in an octagon. The reflector (103) shown in FIGS. 1 and 2 is therefore really one of a series of reflectors (103), each arranged so that light from any direction is reflected into the internal mirrors and then back out of the reflector (103) in the opposing direction regardless of the light's incident direction. A reflector (103) therefore allows for laser light, incident in any original direction, to be reflected at the reverse angle after reflecting through a particular one of the reflector's (103) surfaces. In the depicted embodiment that is rear wall (131).

The reflector (103) provides two functionalities. Firstly, because the reflector (103) will reflect light down the same path taken incident to the reflector (103), light which hits the decoy (100) will be sent back to the rangefinder. This can help to increase the intensity of the light reflected from the reflector (103) that is received by the rangefinder because, as opposed to the target vehicle where angled shapes or surfaces may reflect light at an angle away from the rangefinder, the reflector (103) will reflect the light incident upon it back to the rangefinder. Secondly, because of its shape, light incident on the reflector (103) reflects into the rear wall (131) and therefore is sent into the walk coil (105) which provides for a false signal.

The reflector (103) may also be designed, in an embodiment, to have highly reflective surfaces so it will generally reflect a higher percentage of the light incident upon it back to the rangefinder, by area, than the vehicle will. Generally, military vehicles are painted in camouflage patterns to hide them from visual detection. This painting is usually done in natural dark colors which do not perfectly reflect light but will absorb some of the laser light. Sometimes, military paints can even be designed to purposefully absorb light at particular frequencies to try and hide the tank from laser systems. Because of this absorption by the vehicle, not all the light incident on the vehicle is reflected back to the rangefinder. In some cases, only a very small percentage of light is reflected back.

Further, the shape of certain vehicles are designed to purposefully not reflect light directly back towards its source, further decreasing the amount reflected. Since the reflector (103) is purposefully designed to reflect light and direct that reflected light back to the source along the same path, it can return a better or greater light signal even with a smaller area than what is returned by the vehicle as a whole. Therefore, a reflector (103) will generally be able to return a higher percentage of incident laser light to the rangefinder, which will preferably allow for it to produce a larger signal than the light reflecting from the vehicle. Thus, any alteration done to the light which hits the decoy (100) will preferably appear to the rangefinder as a stronger signal than the actual reflection. This is discussed in more detail later.

As mentioned in the previous paragraph, before the light is reflected back to the rangefinder, the incident light is directed onto the rear wall (131) and into walk coil (105). Traditionally, rear wall (131) of a retro reflector is mirrored, however, as shown in FIG. 2, rear wall (131) may be partially mirrored or may be transparent to the incident light. Therefore, the light is transmitted through rear wall (131) and into walk coil (105). Walk coil (105) provides for the decoy distance. In a preferred embodiment, walk coil (105) comprises a coil of fiber optic cable or other light transmitting material and includes or terminates in a mirror (107) or other reflective surface. In an embodiment, the mirror (107) may be located at a second end of the walk coil (105) with the first end of the walk coil at the rear wall (131). In another embodiment the mirror (107) may be located anywhere within walk coil (105). In this way, the laser light (201) incident on the reflector (103) enters walk coil (105), travels down the walk coil (105) from the first end towards the second end, is reflected from mirror (107), travels back through the walk coil (105) towards the first end and leaves the walk coil (105) at the opposing angle to which it entered (this is a property inherent of such coils so long as mirror (107) is flat relative to the coil.). The light (211) then reenters the reflector (103) at the opposite angle to which it entered the walk coil (105) at the rear wall (131). This is the same as if rear wall (131) was a mirror which is the case in a standard retro-reflector. The light's reflection by reflector (103) is then completed and is directed back toward the rangefinder. As can be seen, the laser which hits the decoy therefore is reflected off of mirror (107). Because walk coil (105) has some length, this light has actually traveled a distance (equal to twice the length of the walk coil (105) prior to the mirror) further than the decoy actually is. Therefore the light has tracked a distance greater than the distance from the rangefinder to the decoy (100).

In another embodiment, each reflector (103) may have a plurality of walk coils (105), each walk coil (105) providing for a slightly different distance signals by having different lengths. In this way, numerous different signals are sent back to the rangefinder. In a still further embodiment, rear wall (131) may comprise a beam splitter or similar device which creates numerous false signals by reflecting some of the incident light while allowing other parts of the incident light to pass into walk coil (105). Note, while walk coil (105) has been referred to herein as a “coil” one of ordinarily skill in the art would understand that coiled structures are beneficial for space considerations but are by no means required. The walk coil (109) can comprise any strand of fiber optic or other cable capable of transmitting electromagnetic radiation which has a predetermined length.

In use, the walk coil (105) efficiently delays the laser by sending the laser light an additional distance equal to twice the length of the walk coil (105) that is in front of the mirror (107). As discussed previously, since a laser rangefinder equates the time it took for the reflection to return as the distance to the object, the light reflected by the decoy (100) effectively encodes that the decoy (100) is further than it actually is by sending the light an additional distance before it is allowed to reflect. To put this another way, the light's reflection alternately shows the distance to the mirror (107) following the walk coil (105) but in straight-line distance, the mirror (107) is generally closer.

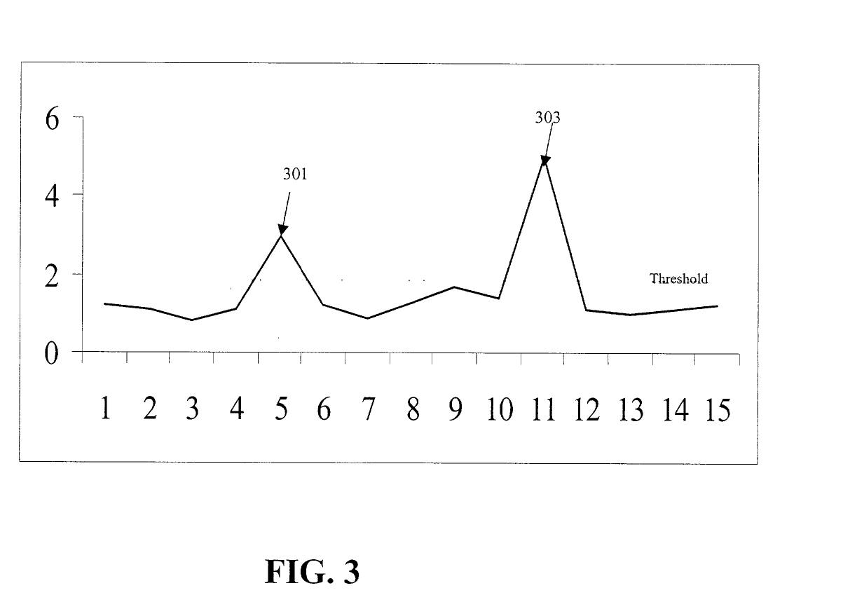

In operation, the embodiment of FIGS. 1 and 2 provides that both the reflection from the target and the reflection from the decoy are received by the rangefinder. Since most rangefinders look for the largest (and/or strongest) reflection to determine the target as discussed above, by building the decoy (100) to be highly reflective, the system (even though smaller than the tank) can provide a higher intensity return than the target's actual reflection. In this way, when the rangefinder receives the light reflections back, the rangefinder will effectively receive two light spikes, a nearer one which represents the intensity of light reflection from the target and shows the correct distance to the target and a later one from the light traveling the additional distance inside the walk coil (105) which will show a distance greater than the actual distance to the decoy. An embodiment of such a return is shown in FIG. 3 with a spike for the actual vehicle at point (301) and the spike produced by the decoy (100) at point (303). This type of return will generally lead to the firer overshooting the target as they shoot at the strongest return which is the decoy signal.

The embodiment of a return shown in FIG. 3 shows a tank which is stationary and a decoy which provides for no additional motion in the decoy (100). In another embodiment, the system can be altered so that the decoy (100) provides a false signal indicating that the target appears to be moving at a rate different. It would be clear to one of ordinary skill in the art that if the object on which the decoy (100) is mounted is moving, the decoy signal produced by the decoy (100) may also appear to be moving. In this embodiment, however, the decoy adds another movement component to the signal. In an embodiment, a stationary vehicle may actually be detected by the rangefinder, but the rangefinder receives a signal indicating the target is moving. In still another embodiment, the actual motion of the vehicle may be cloaked by the decoy motion as it is effectively hidden within the decoy signal. These types of systems are particularly useful against pulsed laser systems where pulses of laser light are fired over a short period of time.

Embodiments incorporating false movement signals may use one or more methods to generate the false motion. In a first method, the mirror (107) is placed so as to be able to move within the walk coil (105) or otherwise adjust its position to change the length of walk coil (105). The mirror (107) is then moved at a predetermined velocity within the walk coil (105). The motion of the mirror (107) is detected by the rangefinder and makes the distance signal appear to be moving (as indeed it is because the signal is detecting the mirror's (107) movement). If the target was also moving, the mirror's (107) movement may simply alter the apparent motion by superimposing its motion on the actual motion. The result would therefore be a composite of the two motions. In another embodiment, beam splitters or similar devices may be used within the walk coil (105) at different locations to provide multiple different signals of different intensities which can resemble a vehicle in motion. Alternatively, the beam splitters could simply provide a number of different spikes, all of which appear to be the vehicle so that it is difficult to determine which actually is the vehicle. In still another embodiment, instead of having a mirror (107) which moves within the fiber optic coil (109) a series of moving mirrors (e.g. rotating mirrors) could be used to simulate motion by creating an apparent change in the length of walk coil (105) without actually doing so.

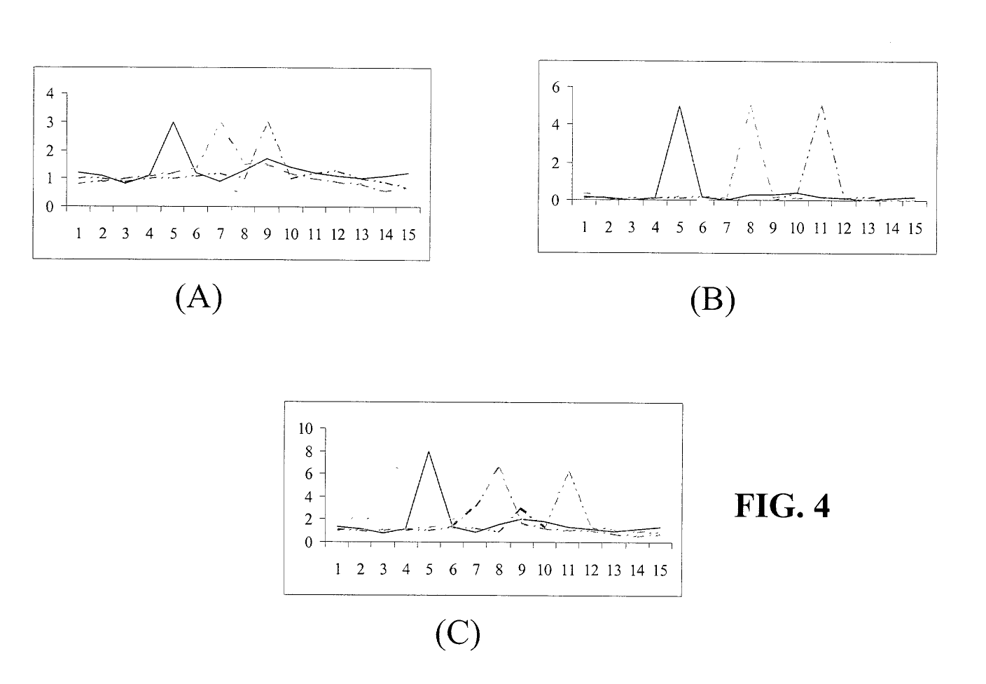

In the alternative embodiments which allow for artificial motion, the target may be even better at concealing its location as its location is correct so there is only a single large spike, but the effect of the decoy is actually to conceal the motion which is lost in the signal provided by the decoy. Whereas in FIG. 2, there are two separate signals. It is, therefore, even more difficult to determine a real signal from a spoofed signal as the signals are not separate, but are hidden within each other. A return from an embodiment of a motion-generating system is shown in FIG. 4 with each of the different lines representing a different laser pulse reflection in each graph. In FIG. 4A the actual motion (the distance between peaks) is visible as being about “2.” FIG. 4B shows a decoy signal with the distance between the pulses being the inaccurate measurement of about “3.” FIG. 4C finally shows the combined return of both FIGS. 4A and 4B (what would actually be received) showing the apparent distance to also be about “3” and concealing the actual motion as noise.

In still another embodiment, the decoy (100) can be adjusted to spoof rangefinders that expect for the decoy (100) to be operating. For instance, once a firer has determined that when a decoy (100) is used the largest spike is not the tank but the decoy, the firer may fire at the smaller, earlier, spike. In such a situation, the decoy (100) could be adjusted to reflect most light with no delay but some light with some delay, therefore it effectively hides the vehicles signature in a larger return, while creating a smaller decoy return again potentially deceiving the rangefinder. Alternatively, the signal return from decoy (100) could be adjusted to appear similar in intensity to the tank's actual reflection. In still another embodiment, the decoy could provide an indication of motion to the tank's actual reflection. In an embodiment, a series of mirrors could be used such that each successive mirror is at a slightly greater distance from the rear wall (131) as the pulses cycle between mirrors, decoy (100) alters the apparent motion of a vehicle, while still providing the actual location which can cause a rangefinder to miss the target even though the position is correct.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A laser decoy system comprising:
a reflector;
a walk coil having first and second ends; said first end operatively attached to said reflector such that light incident on said reflector is directed into said coil; and
a mirror operatively connected to said coil such that light traveling from said first end of said coil toward said second end of said coil is deflected by said mirror to travel from said second end of said coil toward said first end of said coil;
wherein light waves incident on said reflector from a first angle are directed into said coil, reflected from said mirror, returned to said reflector and are reflected back at a second angle generally being the opposite of said first angle.

2. The decoy system of claim 1 wherein said reflector has total internal reflectance.

3. The decoy system of claim 1 wherein said walk coil comprises a strand of fiber optic cable.

4. The decoy system of claim 3 wherein said strand of fiber optic cable is coiled.

5. The decoy system of claim 1 wherein said mirror is located within said walk coil.

6. The decoy system of claim 1 wherein said mirror is located at said second end of said walk coil.

7. The decoy system of claim 1 wherein said mirror can move relative to said second end.

8. The decoy system of claim 1 wherein said walk coil includes a plurality of mirrors.

9. The decoy system of claim 1 wherein said walk coil includes at least one beam splitter.
